(19) United States
(12) Patent Application Publication
(10) Pub. No.: US 2022/0338286 A1
(43) Pub. Date: Oct. 20, 2022

(54) METHODS AND DEVICES IN A DUAL CONNECTIVITY NETWORK

(71) Applicant: Telefonaktiebolaget LM Ericsson (publ), Stockholm (SE)

(72) Inventors: Alberto Gonzalez Escudero, Linköping (SE); Thomas Johansson, Åby (SE)

(21) Appl. No.: 17/641,130

(22) PCT Filed: Sep. 9, 2019
(86) PCT No.: PCT/SE2019/050842

§ 371 Date: Mar. 8, 2022

(51) Int. Cl. H04W 76/15; H04W 72/14; H04W 24/10

(52) U.S. Cl. CPC H04W 76/15; H04W 72/14; H04W 24/10

(57) ABSTRACT

The proposed technology provides complementary methods and devices that enable a more efficient control of data communication in a Dual Connectivity Network. Disclosed is a method and a corresponding node and computer program for operating a Secondary Node, SN, in a wireless communication network during a dual connectivity connection where said SN and a Master Node, MN, provides services to at least one User Equipment. Also disclosed is a method and a corresponding node and computer program for operating a Master Node, MN, in a wireless communication network during a dual connectivity connection where said MN and a Secondary Node, SN, provide services to at least one User Equipment, UE.

### TECHNICAL FIELD

The proposed technology generally relates to methods and devices in a dual connectivity network. It relates in particular to methods and devices that enables the serving network nodes to provide an efficient service to a wireless device, e.g., a User Equipment—UE, served by the network nodes. Also disclosed are computer programs for executing the methods as well as computer program products comprising the computer programs.

### BACKGROUND

Dual connectivity is commonly used in modern wireless networks to provide a more efficient use of the available network resources. When in dual connectivity mode a wireless device, such as a UE, is connected to two different serving network nodes, a primary network node, referred to as a Master Node—MN, and also a Secondary Node—SN. The DC concept as such is not new in cellular networks. In its simplest form, it allows two network nodes, e.g., base stations, to simultaneously deliver user data to a mobile device. DC between LTE base stations was introduced in 3GPP Release-12, completed in March 2015, and DC-like aggregation of LTE and WLAN was introduced in 3GPP Release-13, completed in March 2016. A modern dual connectivity mode, DC mode, is LTE-NR dual connectivity, in which user data can be exchanged between a UE and an NR base station along with the LTE connectivity.

Since the underlying technology components and capabilities are not the same for LTE and NR, there have been a number of challenges to resolve before completing the first NR release in 3GPP Release-15. The first solution to be standardized is Evolved-Universal Terrestrial Radio Access-New Radio dual connectivity—EN-DC.

In EN-DC, the MN is LTE, and the secondary node, the SN, is NR. Note that the term “node” in its most simple from refers to a base station.

To provide additional background information, consider the simplified wireless communication system illustrated in FIG. 1. Here it is disclosed a UE 3, which communicates with two access nodes 100; 200, using radio connections 107-108. The access nodes 100-200 are connected to a network node 106 and to each other over a X2 or Xn interface 108. The access nodes 100; 200 are part of the radio access network 10. For wireless communication systems pursuant to 3GPP Evolved Packet System, EPS, also referred to as Long Term Evolution, LTE, or 4G, standard specifications, such as specified in 3GPP TS 36.300 and related specifications, the access nodes 100-200 corresponds typically to an Evolved NodeB, eNodeB, and the network node 106 corresponds typically to either a Mobility Management Entity, MME, and/or a Serving Gateway, SGW. The eNodeB is part of the radio access network 10, which in this case is the Evolved Universal Terrestrial Radio Access Network, E-UTRAN, while the MME and SGW are both part of the Evolved Packet Core network, EPC.

For wireless communication systems pursuant to 3GPP 5G System, 5GS, also referred to as New Radio, NR, or 5G, standard specifications, such as specified in 3GPP TS 38.300 and related specifications, on the other hand, the access nodes 100-200 corresponds typically to an 5G NodeB, gNodeB, and the network node 106 corresponds typically to either a Access and Mobility Management Function, AMF, and/or a User Plane Function, UPF. The gNodeB is part of the radio access network 10, which in this case is the Next Generation Radio Access Network, NG-RAN, while the AMF and UPF are both part of the 5G Core Network, 5GC. The gNodeB is sometimes referred to as an NG-RAN node.

In 3GPP dual connectivity between LTE and LTE, LTE and NR has been standardized. An example of such a configuration is EN-DC in which a UE is connected to one eNodeB that acts as a MN and one en-gNodeB that acts as a SN. The eNodeB is connected to the EPC via the S1 interface and to the en-gNodeB via the X2 interface. The en-gNodeB might also be connected to the EPC via the S1-U interface and other en-gNodeBs via the X2-U interface standard configuration EN-DC. In this disclosure EN-DC will be used as an example but the proposed technology is valid for other dual connectivity configurations.

Multi-Radio Dual Connectivity, MR-DC, described in 3GPP TS 37.340, is a generalization of the Intra-E-UTRA Dual Connectivity, where a multiple Rx/Tx UE may be configured to utilize resources provided by two different nodes connected via non-ideal backhaul, one providing NR access and the other one providing either E-UTRA or NR access. One node act as the MN and the other as the SN. The MN and SN are connected via a network interface and at least the MN is connected to the core network.

Various variants of how the SN may be added to the MN is specified in 3GPP TS 37.340 for EN-DC and MR-DC with 5GC. Details are provided in the appendix comprised in this application.

Despite the ongoing evolution of DC, there are still room for additional improvements. It is in particular desirable to provide mechanism that enables more efficient data communication and a more seamless mobility within the dual connectivity network. The proposed technology aims to provide such mechanism.

### SUMMARY

It is a general object of the proposed technology to provide mechanism that enable a more efficient data communication and a more efficient mobility within a dual connectivity connection. The proposed mechanism is based on a conditionally granted right for a SN to configure more measurement frequencies than those initially allocated to the SN by the MN. These additional measurement frequencies can be used to obtain a more node specific measurement report that can be used as a basis for controlling both mobility within the network but also increase the overall data communication performance.

It is a particular object of the proposed technology to provide a method for operating a SN during dual connectivity that enables the SN to obtain more frequency measurements from a UE served by the SN.

It is another object to provide a complementary method for operating a MN during dual connectivity that enables a SN to obtain more frequency measurements from a UE served by the SN.

It is still another object to provide a network device in a SN in a dual connectivity network that enables the SN to obtain more frequency measurements from a UE served by the SN.

It is yet another object to provide a network device in a MN in a dual connectivity network that enables the SN to obtain more frequency measurements from a UE served by the SN.

An additional object is to provide computer programs which, when executed, enables a SN to obtain more frequency measurements from a UE served by the SN.

Still another additional object is to provide computer program products comprising the computer programs which, when executed, enables a SN to obtain more frequency measurements from a UE served by the SN.

These and other objects are met by embodiments of the proposed technology.

According to a first aspect, there is provided a method for operating a Secondary Node, SN, in a wireless communication network during a dual connectivity connection where the SN and a Master Node, MN, provides services to at least one User Equipment. The method comprises sending a request to the MN, the request comprising a selection of frequencies the SN wants a UE to perform measurements on. The method also comprises configuring, based on the response to the request, the UE to perform measurements on at least part of the frequencies in the selection of frequencies.

According to a second aspect, there is provided a method for operating a Master Node, MN, in a wireless communication network during a dual connectivity connection where the MN and a Secondary Node, SN, provides services to at least one User Equipment, UE. The method comprises receiving a request comprising a selection of frequencies that the SN wants a UE to perform measurements on. The method also comprises determining whether to at least partially grant the request whereby at least a subset of the frequencies comprised in the selection of frequencies are subject to the grant. The method further comprises sending, subject to the grant, a response to the SN.

According to a third aspect, there is provided a network device in a Secondary Node, SN, in a wireless communication network having a dual connectivity connection where the SN and a Master Node, MN, provides services to at least one User Equipment. The network device is configured to send a request to the MN, the request comprising a selection of frequencies the SN wants a UE to perform measurements on. The network device is also configured to configure, based on the response to the request, the UE to perform measurements on at least part of the frequencies in the selection of frequencies.

According to a fourth aspect, there is provided a network device in Master Node, MN, in a wireless communication network having a dual connectivity connection where the MN and a Secondary Node, SN, provides services to at least one User Equipment, UE. The network device is configured to receive a request comprising a selection of frequencies that the SN wants a UE to perform measurements on. The network device is also configured to determine whether to at least partially grant the request whereby at least a subset of the frequencies comprised in the selection of frequencies are subject to the grant. The network device is also configured to send, subject to the grant, a response to the SN.

According to a fifth aspect, there is provided a computer program computer program for operating, when executed by a processor, a network device in a Secondary Node, SN, in a wireless communication network having a dual connectivity connection where the SN and a Master Node, MN, provides services to at least one User Equipment. The computer program comprises instructions, which when executed by the processor, cause the processor to initiate the sending of a request to the MN, the request comprising a selection of frequencies the SN wants a UE 3 to perform measurements on, and initiate, based on the response to the request, a configuration of the UE to perform measurements on at least part of the frequencies in the selection of frequencies.

According to a sixth aspect, there is provided a computer program for operating, when executed by a processor, a network device in Master Node, MN, in a wireless communication network having a dual connectivity connection where MN and a Secondary Node, SN, provides services to at least one User Equipment, UE. The computer program comprises instructions, which when executed by the processor, cause the processor to, read a request comprising a selection of frequencies that said SN wants a UE to perform measurements on, determine whether to at least partially grant the, request whereby at least a subset of the frequencies comprised in the selection of frequencies are subject to the grant, and initiate, subject to the grant, a sending of a response to the SN.

According to a seventh aspect there is provided a computer program product comprising a computer-readable medium carrying a computer program according to the fifth or sixth aspect.

One of the advantages associated with this proposed technology is that it provides a flexible procedure for controlling the number of frequencies to measure in a dual-connectivity connection configuration. By allowing the SN to dynamically alter the number of frequencies that a UE shall perform measurements on, it will be possible to obtain more up to date and more complete measurement reports. These measurement reports may then be used to enable more efficient data communication within the dual connectivity network and also enable a better mobility control with the dual connectivity network. Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic illustration of a wireless communication network supporting dual connectivity whereby a SN and a MN provides services to a UE.

FIG. 2 is a schematic illustration of a flow diagram illustrating a method for operating a SN according to the proposed technology.

FIG. 3 is a schematic signaling diagram illustrating the communication between a MN and a SN according to the proposed technology.

FIG. 4 is a is a schematic illustration of a flow diagram illustrating a method for operating a MN according to the proposed technology.

FIG. 5 is a schematic illustration of a flow diagram illustrating a particular embodiment of a method for operating a MN according to the proposed technology.

FIG. 6 is a schematic signaling diagram illustrating the communication between a MN, a SN and a UE according to the proposed technology.

FIG. 7 is a schematic block diagram illustrating a network device in a SN according to an embodiment of the proposed technology.

FIG. 8 is a schematic block diagram illustrating a network device in a MN according to an embodiment of the proposed technology.

FIG. 9 is a is a schematic block diagram illustrating a network device in a MN or a SN according to an alternative embodiment of the proposed technology.

FIG. 10 is a schematic block diagram illustrating a computer program implementation according to an embodiment of the proposed technology.

FIG. 11 is a schematic diagram illustrating an example of how the functionalities of the proposed technology can be distributed or partitioned between different network devices in a general case.

### DETAILED DESCRIPTION

Throughout the drawings, the same reference designations are used for similar or corresponding elements.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

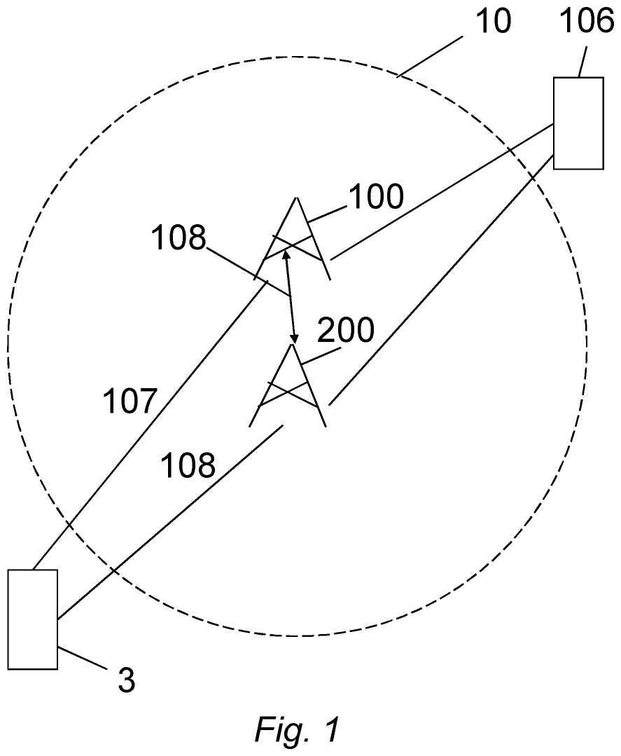

For a better understanding of the proposed technology, it may be useful to begin with a brief system overview. We will describe the relevant background based on the DC scenario of EN-DC. This is however merely one of the DC cases where the proposed technology is useful. Other cases will be described in what follows. EN-DC is DC scenario that utilizes two different generations of 3GPP radio access technologies, namely Long Term Evolution, LTE, and New Radio, NR. In EN-DC is the MN a LTE node, and the SN is a NR node, i.e., base stations of different radio access technologies. Reference is now made to FIG. 1. FIG. 1 illustrates a UE 3, which communicates with two nodes, a SN 100 and a MN 200, using radio connections 107-108. Depending on bearer configuration, the user plane termination point can be in MN 200 or in SN 100. In the control plane, used to carry signaling traffic between the UE and the core network, it is however only the MN that has an interface towards EPC when in EN-DC. In this particular scenario is the LTE node responsible for maintaining, e.g., connection state transitions, the managing of the connection setup and connection release, and also for initiating secondary node additions—see the appendix for details.

In EN-DC, as a contrast to LTE, a mobile device may be provided with a second Radio Resource Control RRC termination, RRC termination, at the SN. RRC signaling relates to signaling between the nodes within the network and the wireless device served by the nodes and the particular type of signaling may for example be a connection reconfiguration and measurement reporting. These types of signaling enables a better controlled mobility and data communication. Several types of Signaling Radio Bearers, SRBs, are used for conveying the RRC message. In what follow we will mainly be concerned with a particular kind of SRB, namely SRB3. SRB3 is an SRB that enables RRC information from the SN to be directly communicated to the UE.

A particular drawback associated with DC as exemplified by EN-DC is related to the measurement procedure. That is, to the procedure that configures the UE with frequencies to perform measurements on. There are several constraints that controls how a UE can be configured for measurements. It should first of all be noted that a UE is not required to measure more than 13 frequencies. It should also be noted that there are several additional constraints that comes into play when the UE is in a DC state. Such constraints are exemplified by the content of section 8.1.2.1.1b.1 in 3 GPP spec 36.133 v16.2.0, which relates to the maximum allowed layers for multiple monitoring for UE in NSA operation. Below we briefly review the content of section 8.1.2.1.1b.1 to clarify the frequency constraints that controls the measurement procedure. To this end, note that Pcell refers to the primary cell in the group of serving cells associated with the MN, PScell refer to the primary cell in the group of serving cells associated with SN, while SCell refers to a secondary cell within a cell group in MN or SN. The following abbreviations are also used in the section below:

### FDD Frequency Division Duplex

### TDD Time Division Duplex

### UTRA Universal Terrestrial Radio Access

### E-UTRA Evolved UTRA

GSM Global System for Mobile communication

### LPP LTE Positioning Protocol

### RSTD Reference Signal Time Difference

A UE that is configured with NR PSCell shall be capable of monitoring at least the following carriers per Radio Access Technology group, RAT group:

Depending on UE capability, 6 FDD E-UTRA inter-frequency carriers configured by PCell.
Depending on UE capability, 6 TDD E-UTRA inter-frequency carriers configured by PCell, and
Depending on UE capability, 7 NR inter-RAT carriers excluding NR serving carrier(s) configured by PCell, and
Depending on UE capability, 7 NR inter-frequency carriers configured by NR PSCell.
Depending on UE capability, 3 FDD UTRA carriers.
Depending on UE capability, 3 TDD UTRA carriers.
Depending on UE capability, 32 GSM carriers, where one GSM layer corresponds to 32 carriers.
Depending on UE capability, 1 FDD E-UTRA inter-frequency carrier for RSTD measurements configured via LPP 24.
Depending on UE capability, 1 TDD E-UTRA inter-frequency carrier for RSTD measurements configured via LPP.

In addition to the requirements defined above, a UE shall be capable of monitoring a total of at least 13 effective carrier frequency layers comprising of any above defined combination of E-UTRA FDD, E-UTRA TDD, UTRA FDD, UTRA TDD, GSM, where one GSM layer corresponds to 32 carriers, and NR layers.

A UE shall be capable of monitoring a total of at least seven effective NR carrier frequency layers excluding NR serving carrier(s), comprising any above defined combination of NR inter-RAT carriers excluding NR serving carrier(s) configured by PCell and NR inter-frequency carriers configured by NR PSCell.

Based on the above it follows that the configuration of seven NR frequencies from the total of 13 frequencies may be distributed between the MN and the SN. This is due to the fact that there are seven NR inter-RAT carriers excluding NR serving carrier(s) configured by PCell, and 7 NR inter-frequency carriers configured by NR PSCell. Note that a frequency configured by the MN, e.g., the eNodeB and a frequency configured by the SN, e.g., the gNodeB is in this context counted as one if they are the same, as described earlier. Note also that the UE might, in special cases, support more frequency measurements but this is not guaranteed, and the UE is allowed to ignore any frequencies in excess of thirteen.

Specific measurements, including selection of specific frequencies to measure on, may thus be configured by both the MN and the SN when in an EN-DC configuration. For a UE in EN-DC configuration, the total limit on the number of frequencies to measure on is, as was mentioned above 13, excluding Pcell, PScell and Scells and the number of frequencies (NR) that can be configured by both the MN and the SN amounts to seven. The fact that the SN as well as the MN may configure a UE for measurements together with the fact that they may have different purposes for selecting the frequencies associated with the measurements may cause some internal conflicts. Consider the case where the SN in EN-DC is a gNodeB. The SN might be interested in measurement reports that is associated with NR measurements to better control NR leg mobility in EN-DC and carrier aggregation. The MN, an eNodeB in EN-DC, may however at the same time be interested in measurement reports associated with NR measurements to enable a better controlled release with redirect to NR Stand Alone. To further clarify a possible internal conflict when both MN and SN are allowed to configure the UE for measurement, consider the set-up of EN-DC. Assume that the gNodeB wants to configure the UE with six NR frequencies to perform measurements on with e.g., the intention to set up carrier aggregation with certain cells in those frequencies. The configuration of the six measurement objects may for example be done using SRB3. Note that even if the eNodeB has indicated max number of allowed inter frequency measurements to gNodeB, in this example 6, it will not be aware of the actual number of configured measurement objects, i.e., the frequencies, due to the use of SRB3. The eNodeB may on the other hand want a measurement report from the UE that can be used as e.g., a basis for moving the UE to NR standalone. This may for example comprise four NR frequencies. What we have now is a competition between the nodes since the UE is limited to seven total unique NR frequencies, a requirement set by the 3GPP specification described earlier, among the maximum number of frequencies that are 13 for the combination of NR and LTE.

Current practice provides the following alternatives for handling the situation:

The gNodeB, may, regardless of limit received from eNodeB, require the eNodeB to configure six frequencies via SGNB MODIFICATION REQUIRED. If the modification is accepted, the eNodeB will send an RRC reconfiguration to the UE. But the UE was already reconfigured via SRB3 by gNodeB which make SRB3 not useful for measurement configuration.

Depending on eNodeB needs, the eNodeB updates the gNodeB with the maximum number of NR frequencies for gNodeB to measure and gNodeB configures the NR measurements using SRB3. If eNodeB configures the four frequencies and sends a SGNB MODIFICATION REQUEST with the new limit of 3 NR frequencies to the gNodeB, gNodeB may react by:
Deconfiguring three measurement objects, as the MN, i.e., the eNodeB decides the UE configuration. After that the gNodeB can send a SGNB MODIFICATION REQUIRED requesting six measurement objects, which the eNodeB might accept or reject. If accepted, this option causes the UE to be reconfigured twice, as in the previous option.
Refuse the modification and send a SGNB MODIFICATION REQUEST REJECT. This might cause different behavior depending on UE implementation, the eNodeB might for example decide to stop dual connectivity or move to another node.
Accept the modification and send the six measurements in the response to the SGNB MODIFICATION REQUIRED.

This is however a misuse of the message and, as the change is accepted but it is answered with a secondary cell group configuration that does not match what the MN says, effectively rejecting it. An eNodeB designed on the assumption of a friendly gNodeB might pass the faulty configuration to the UE which will ignore some of the frequencies based on UE implementation.

It is thus clear, based on the above, that that none of the alternatives are ideal for resolving potential internal conflicts that follows from the ability of both the MN and SN to configure a UE for frequency measurements.

It is thus highly desirable to find mechanism that at least in part alleviates the drawback associated with the ability of both the MN and SN to configure a UE for measurements. If such mechanism was found it would improve the controllability of UE mobility within the DC configuration and would also improve the overall data communication since the measurement reports form the basis for selecting suitable data communication channels.

The proposed technology aims to provide such a mechanism. The mechanism is based on actions where the SN request the MN to reserve certain slots for SN specific measurements. That is, the SN selects a number of frequencies for which a measurement report is desired. Before configuring the UE to perform the measurements the SN communicates and negotiates with the MN based on the selected list of frequencies. If the request from the SN is, at least partially, granted by the MN, the SN may proceed and configure the UE for measurements based on the granted set of frequencies. This mechanism may in certain scenarios also avoid unnecessary triggering of additional RRC reconfigurations to the UE. The proposed technology enables the DC nodes, SN and MN, to obtain more node specific measurement reports, i.e., obtain measurement reports on frequencies considered relevant by a specific participating node, but with a reduced amount of the earlier mentioned conflicts. The outcome of the measurements that the UE has been configured for may be reported by the UE to the particular node, MN or SN, that was responsible for the configuration. The information in the measurement report may then be shared by MN and SN in order to obtain a better controlled data communication over the DC network.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

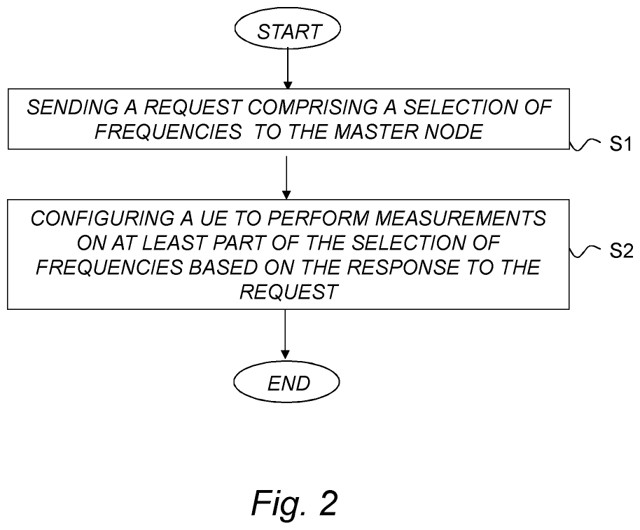

FIG. 2 is a schematic flow diagram illustrating an example of a method for operating a Secondary Node, SN, 1 in a wireless communication network during a dual connectivity connection where the SN 1 and a Master Node, MN, 2 provides services to at least one User Equipment. The method comprises sending S1 a request to the MN 2, the request comprising a selection of frequencies the SN 1 wants a UE 3 to perform measurements on. The method also comprises configuring S2, based on the response to the request, the UE 3 to perform measurements on at least part of the frequencies in the selection of frequencies.

In other words, the proposed technology provides a method wherein a SN in a dual connectivity network may request that certain specified frequencies that will form the basis of a measurement report generated by a UE serviced by the nodes, that is the SN and the MN, in the dual connectivity connection is granted at least in part by the MN. Having obtained this conditional grant, conditional since the MN may decide to grant only a subset of the requested frequencies, the SN will continue and configure the UE based on the granted frequencies. One upside of the proposed technology is that the MN is informed of the number of frequencies and the spectrum of the frequencies that will be configured by the SN. This exchange of information will ensure that at least part of the problems associated with conflicts described earlier can be avoided. The granted set of frequencies will in addition provide the SN with a SN specific measurement report that can be used for planning e.g., mobility in EN-DC and carrier aggregation.

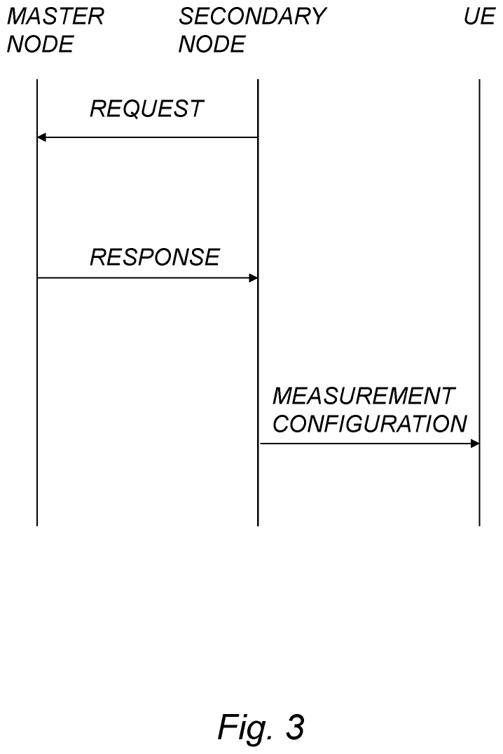

As a highly simplified example, consider the signaling diagram in FIG. 3. As a basis for the signaling the SN has selected a number, or a set, of frequencies {fn} which are considered relevant as a basis for a measurement report. The selected frequencies may for example be considered relevant for planning carrier aggregation. Having selected the frequencies {fn} SN sends a request to the MN asking the MN to grant at least part of the selected frequencies. On the MN side of the network, the MN will determine whether to at least conditionally grant the request, i.e., by granting a subset of the frequencies, and convey the outcome of the determination step to the SN in a response. The outcome may be communicated to the SN over the X2 interface in this example. Having obtained the response to the grant, the SN may continue and configure the UE to perform the measurements that were subject to the grant. It may for example be that only a subset of the frequencies {fn}, i.e., {fm} where m<n, were subject to the grant and in this case the SN may configure the UE to perform measurements on these m frequencies. The upshot is that the MN as well as the SN has knowledge about the frequencies that form the basis of the measurement configuration of the UE.

According to a particular embodiment of the proposed technology there is provided a method wherein the request further comprises instructions that the MN 2 should refrain from configuring the UE 3 for measurements connected to the selection of frequencies comprised in the request. This particular embodiment will ensure that the UE is not provided with configuration and reconfiguration messages from both nodes but instead is controlled solely by the SN.

According to a particular embodiment of the proposed technology there is provided a method wherein the request is sent to the MN 2 in a new information element provided in an existing message type. This embodiment would give a highly simplified communication mode relating to these issues that in turn would enable a swift grant of the request.

According to a particular embodiment of the proposed technology there is provided a method, wherein the SN 1 is an gNodeB and the MN 2 is an eNodeB and wherein the dual connectivity connection is an EN-DC or a NGEN-DC configuration.

In the first alternative configuration, EN-DC, the UE is connected to one eNodeB that acts as a MN and to one en-gNodeB that acts as a SN. The eNodeB is connected to the EPC via the S1 interface and to the en-gNodeB via the X2 interface. The en-gNodeB might also be connected to the EPC via the S1-U interface and other en-gNodeBs via the X2-U interface.

In the second alternative configuration, NGEN-DC, the UE is connected to one ng-eNodeB that acts as a MN and one gNodeB that acts as a SN. The ng-eNodeB is connected to the 5GC and the gNodeB is connected to the ng-eNodeB via the Xn interface. Additional alternatives exist, the UE could for example be connected to one gNodeB that acts as a MN and one ng-eNodeB that acts as a SN. The gNodeB is connected to 5GC and the ng-eNodeB is connected to the gNodeB via the Xn interface. The UE may also be subject to a NR-NR Dual Connectivity, NR-DC, in which a UE is connected to one gNodeB that acts as a MN and another gNodeB that acts as a SN. The master gNodeB is connected to the 5GC via the NG interface and to the secondary gNodeB via the Xn interface. The secondary gNodeB might also be connected to the 5GC via the NG-U interface. In addition, NRDC can also be used when a UE is connected to two gNodeB-DUs, one serving the MCG and the other serving the SCG, connected to the same gNodeB-CU, acting both as a MN and as a SN.

According to yet another particular embodiment of the proposed technology there is provided a method, wherein the SN 1 is an eNodeB and the MN 2 is an gNodeB and wherein the dual connectivity connection is a NE-DC configuration.

Having described the method for operating a SN in a dual connectivity network, we will now proceed and describe the complementary method for operating a MN in a dual connectivity network. The two complementary methods acts to ensure that measurement reports can be generated based on the desires of the separate nodes while at the same time the negative effects of the internal conflicts emanating from the fact that the MN as well as the SN is capable of configuring a UE for measurements are reduced. An overall technical advantage achieved is that the controllability of mobility within the DC configuration is increased and that the overall data communication performance, which in part hinges on good measurement reports, is improved.

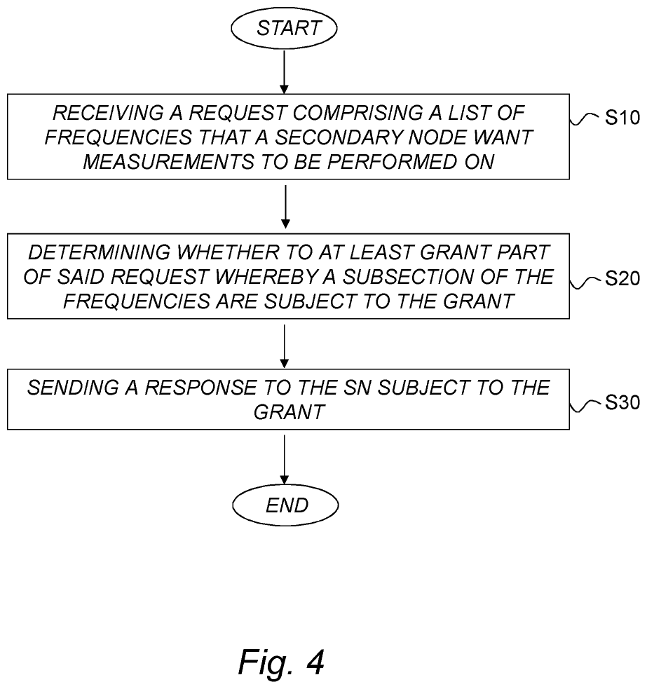

FIG. 4 is a schematic flow diagram illustrating an a method for operating a Master Node, MN, 2 in a wireless communication network during a dual connectivity connection where the MN 2 and a Secondary Node, SN, 1 provides services to at least one User Equipment, UE, 3 according to the proposed technology. The method comprises receiving S10 a request comprising a selection of frequencies that the SN 1 wants a UE 3 to perform measurements on. The method also comprises determining S20 whether to at least partially grant the request whereby at least a subset of the frequencies comprised in the selection of frequencies are subject to the grant. The method also comprises sending S30, subject to the grant, a response to the SN 2. In other words, the MN receives a request from the SN. The request comprises a list or a set of frequencies that the SN desires a measurement report to be based on. Based on the requested frequency list the MN determines whether to grant the request in whole, in part or even refusing the request. If the request is granted in part, i.e., if some, but not all, of the frequencies in the received list are granted, we refer to it as a conditional grant herein. A completely granted request gives the SN the right to configure a UE for measurements with all frequencies in the list. There are however also scenarios where the request cannot be granted and will result in a refused request. Below we will describe several criterions for the various outcome of the determining step. Having determined whether to grant the request, conditionally or as a whole, the MN proceeds and communicates the outcome to the SN to enable the SN to take appropriate actions. If, for example, the grant was conditional giving the right to the SN to configure the UE for measuring some of the frequencies in the list, the SN may proceed accordingly while the MN will have obtained knowledge about the particular number of frequencies and the relevant spectra of the frequencies and may utilize this knowledge to configure the UE for measurement on the remaining available measurement slots, e.g, 13—(number of frequencies granted to the SN) if 13 is the maximum number of measurements that the UE can perform.

According to a particular embodiment of the proposed technology there is provided a method wherein the step S20 of determining whether to at least partially grant the request comprises to grant the request in whole if the number of frequencies in the selection of frequencies is lower or equal to the number of frequencies that the UE 3 can perform measurements on.

According to another embodiment of the proposed technology there is provided a method wherein the step S20 of determining whether to at least partially grant the request comprises to grant the request for a fraction of the frequencies comprised in the selection of frequencies, the fraction being determined by the number of frequencies that the UE 3 can perform measurements on. If for example the SN requests a grant for 15 frequencies, but the UE is only capable of measuring 13, the outcome of the grant may be that 13 frequencies are allowed. Optionally the MN may also decide which two frequencies that are excluded from the grant.

According to yet another particular embodiment of the proposed technology there is provided a method, wherein the step S20 of determining whether to at least partially grant the request comprises to grant the request if the selection of frequencies the SN 1 wants a UE 3 to perform measurements on does not increase the number of frequencies that the UE 3 is able to perform measurements on. If for example the SN requests a grant for 15 frequencies, but the UE is only capable of measuring 13, the outcome of the grant may be that 13 frequencies are allowed. Optionally the MN may also decide which two frequencies that are excluded from the grant. An alternative to granting a subset of the frequencies may be to refuse the grant.

According to still another particular embodiment of the proposed technology there is provided a method wherein the step S30 of sending a response comprises to send a response that instructs the SN 1 to configure the UE 3 to perform measurement on at least the subset of frequencies subjected to the grant. By incorporating this information in the message, the future actions of the SN are clarified and there is no risk that there is a conflict when the UE is configured. That is, the SN will know that it is expected to configure the UE and that the MN will refrain from it.

According to a particular embodiment of the proposed technology there is provided a method wherein the step of sending S30 a response comprises to send a response indicating the maximum number of frequencies that the SN 1 is allowed to configure the UE 3 to perform measurements on. This information is relevant for a conditional grant. By informing the SN about the number of allowed frequencies, the SN might select the most relevant frequencies from the list and proceed with the UE configuration. Alternatively, the MN might select the frequencies that are excluded from the grant and convey the number of allowed frequencies and the excluded frequencies to the SN in the response.

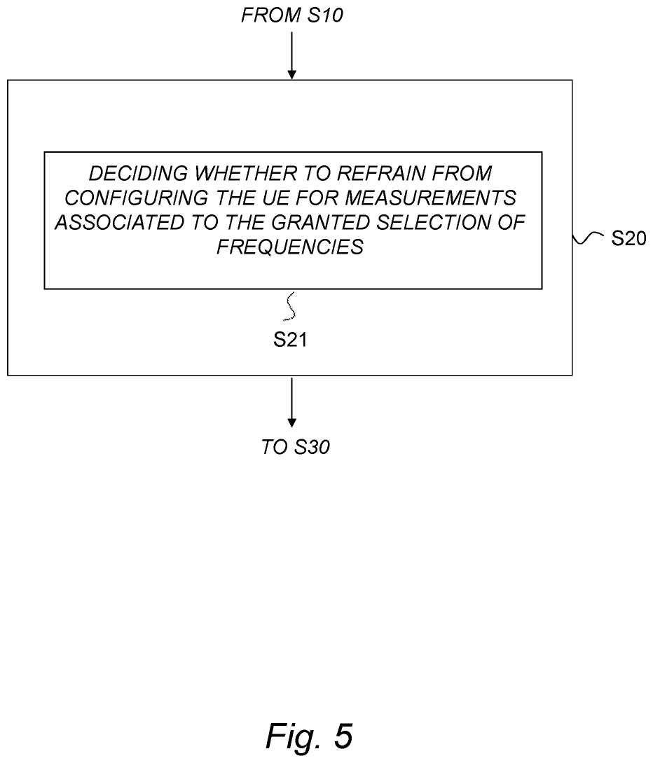

According to a particular embodiment of the proposed technology schematically illustrated in FIG. 5 there is provided a method wherein the received request further comprises a request that the MN 2 should refrain from configuring the UE 3 for measurements associated to the selection of frequencies, and wherein the step S20 of determining whether to at least partially grant the request comprises deciding S21 to refrain from configuring the UE 3 for measurements associated to the selection of frequencies, and wherein the step S30 of sending a response comprises to send a response that indicates that the MN 2 will refrain from configuring the UE 3 for measurements associated to the selection of frequencies. This embodiment ensures that there is no conflicting communication to the UE during configuration of the same. That is, the SN will know that it is expected to configure the UE and that the MN will refrain from it.

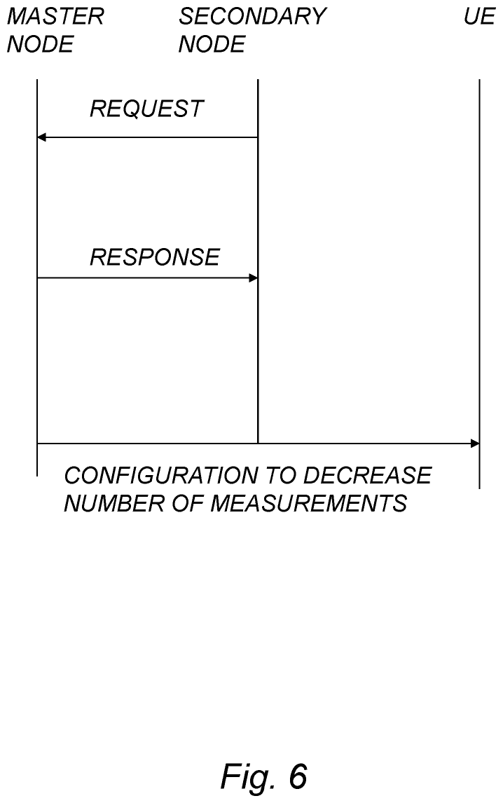

According to a particular embodiment of the proposed technology there is provided a method that also comprises to reconfigure the UE 3 to decrease the number of ongoing measurements if the request has been at least partially granted. The network procedure of this embodiment is schematically illustrated in the signaling diagram of FIG. 6. This embodiment will reduce the strain put on the UE during measurements. Since the MN knows exactly what frequencies and what number of frequencies the SN desires measurement reports on, it can give priority to these by decreasing the number of measurements that the UE is expected to perform to instead concentrate on the granted frequencies. This will ensure 3GPP specified UE behavior and offload some of the burden on the UE and will also reduce unnecessary energy losses associated with measurements.

According to a particular embodiment of the proposed technology there is provided a method wherein the SN 1 is an gNodeB and the MN 2 is an eNodeB and wherein the dual connectivity connection is an EN-DC or a NGEN-DC configuration.

The first alternative, EN-DC, in this embodiment has the UE connected to one eNodeB that acts as a MN and to one en-gNodeB that acts as a SN. The eNodeB is connected to the EPC via the S1 interface and to the en-gNodeB via the X2 interface. The en-gNodeB might also be connected to the EPC via the S1-U interface and other en-gNodeBs via the X2-U interface. The second alternative, NGEN-DC, has the UE connected to one ng-eNodeB that acts as a MN and one gNodeB that acts as a SN. The ng-eNodeB is connected to the 5GC and the gNodeB is connected to the ng-eNodeB via the Xn interface. Additional alternatives exist, the UE could for example be connected to one gNodeB that acts as a MN and one ng-eNodeB that acts as a SN. The gNodeB is connected to 5GC and the ng-eNodeB is connected to the gNodeB via the Xn interface. The UE may also be subject to a NR-NR Dual Connectivity, NR-DC, in which a UE is connected to one gNodeB that acts as a MN and another gNodeB that acts as a SN. The master gNodeB is connected to the 5GC via the NG interface and to the secondary gNodeB via the Xn interface. The secondary gNodeB might also be connected to the 5GC via the NG-U interface. In addition, NRDC can also be used when a UE is connected to two gNodeB-DUs, one serving the MCG and the other serving the SCG, connected to the same gNodeB-CU, acting both as a MN and as a SN.

According to a particular embodiment of the proposed technology there is provided a method wherein the SN 1 is an eNodeB and the MN 2 is an gNodeB and wherein the dual connectivity connection is an NE-DC configuration.

Having described both of the complementary methods in great detail, in what follows we will describe various network devices that are suitable to perform the various steps of the proposed methods. The advantages associated with such devices has been described earlier with regard to the methods and they will not be repeated.

As used herein, the term “network device” may refer to any device located in connection with a communication network, including but not limited to devices in access networks, core networks and similar network structures. The term network device may also encompass cloud-based network devices.

As used herein, the non-limiting terms “wireless communication device”, “station”, “User Equipment UE”, and “terminal” or “terminal device” may refer to a mobile phone, a cellular phone, a Personal Digital Assistant PDA, equipped with radio communication capabilities, a smart phone, a laptop or Personal Computer PC, equipped with an internal or external mobile broadband modem, a tablet with radio communication capabilities, a target device, a Machine-to-Machine M2M device, a Machine Type Communication MTC device, an Internet of Thing IoT device, a Device-to-Device D2D UE, a machine type UE or UE capable of machine to machine communication, Customer Premises Equipment CPE, Laptop Embedded Equipment LEE, Laptop Mounted Equipment LME, USB dongle, a portable electronic radio communication device, and/or a sensor device, meter, vehicle, household appliance, medical appliance, camera, television, radio, lightning arrangement and so forth equipped with radio communication capabilities or the like. In particular, the term “wireless communication device” should be interpreted as non-limiting terms comprising any type of wireless device communicating with a network node in a wireless communication system and/or possibly communicating directly with another wireless communication device. In other words, a wireless communication device may be any device equipped with circuitry for wireless communication according to any relevant standard for communication.

As used herein, the non-limiting term “network node” may refer to base stations, access points, network control nodes such as network controllers, radio network controllers, base station controllers, access controllers, and the like. In particular, the term “base station” may encompass different types of radio base stations including standardized base station functions such as Node Bs, or evolved Node Bs eNodeBs, gNodeBs, and also macro/micro/pico radio base stations, home base stations, also known as femto base stations, relay nodes, repeaters, radio access points, Base Transceiver Stations BTSs, and even radio control nodes controlling one or more Remote Radio Units RRUs, or the like.

It will be appreciated that the methods and arrangements described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors DSPs, one or more Central Processing Units CPUs, video acceleration hardware, and/or any suitable programmable logic circuitry such as one or more Field Programmable Gate Arrays FPGAs, or one or more Programmable Logic Controllers PLCs.

It should also be understood that it may be possible to re-use the general processing capabilities of any conventional device or unit in which the proposed technology is implemented. It may also be possible to re-use existing software, e.g. by reprogramming of the existing software or by adding new software components.

According to an aspect of the proposed technology there is provided a network device 100 in a Secondary Node, SN, 1 in a wireless communication network having a dual connectivity connection where the SN 1 and a Master Node, MN, 2 provides services to at least one User Equipment. The network device 100 is configured to send a request to the MN 2, the request comprising a selection of frequencies the SN 1 wants a UE 3 to perform measurements on. The network device 100 is also configured to configure, based on the response to the request, the UE 3 to perform measurements on at least part of the frequencies in the selection of frequencies.

According to a particular embodiment of the proposed technology there is provided a network device 100 wherein the request further comprises instructions that the MN 2 should refrain from configuring the UE 3 for measurements connected to the selection of frequencies comprised in the request.

According to a particular embodiment of the proposed technology there is provided a network device 100 wherein network device is configured to send the request to the MN 2 in a new information element provided in an existing message type.

According to a particular embodiment of the proposed technology there is provided a network device 100 wherein the SN 1 is an gNodeB and the MN 2 is an eNodeB and wherein the dual connectivity connection is an EN-DC or a NGEN-DC configuration. According to a particular embodiment of the proposed technology there is provided a network device 100, wherein the SN 1 is an eNodeB and the MN 2 is an gNodeB and wherein the dual connectivity connection is a NE-DC configuration.

According to a specific aspect of the proposed technology there is also provided a network device 200 in a Master Node, MN, 2 in a wireless communication network having a dual connectivity connection where the MN 2 and a Secondary Node, SN, 1 provides services to at least one User Equipment, UE, 3. The network device 200 is configured to receive a request comprising a selection of frequencies that the SN 1 wants a UE 3 to perform measurements on. The network device 200 is also configured to determine whether to at least partially grant the request whereby at least a subset of the frequencies comprised in the selection of frequencies are subject to the grant. The network device 200 is also configured to send, subject to the grant, a response to the SN 2.

According to a particular embodiment of the proposed technology there is provided a network device 200 wherein the network device 200 is configured to determine whether to at least partially grant the request by granting the request in whole if the number of frequencies in the selection of frequencies is lower or equal to the number of frequencies that the UE 3 can perform measurements on.

According to a particular embodiment of the proposed technology there is provided a network device 200 wherein the network device 200 is configured to determine whether to at least partially grant the request by granting the request for a fraction of the frequencies comprised in the selection of frequencies, the fraction being determined by the number of frequencies that the UE 3 can perform measurements on.

According to a particular embodiment of the proposed technology there is provided a network device 200 wherein the network device 200 is configured to determine whether to at least partially grant the request by granting the request if the selection of frequencies the SN 1 wants a UE 3 to perform measurements on does not increase the number of frequencies that the UE 3 is able to perform measurements on.

According to a particular embodiment of the proposed technology there is provided a network device 200 wherein the network device 200 is configured to send a response comprising instructions that the SN 1 shall configure the UE 3 to perform measurement on at least the subset of frequencies subjected to the grant.

According to a particular embodiment of the proposed technology there is provided a network device 200 wherein the network device 200 is configured to send a response that comprises an indication of the maximum number of frequencies that the SN 1 is allowed to configure the UE 3 for measurements on.

According to a particular embodiment of the proposed technology there is provided a network device 200 wherein the received request further comprises a request that the MN 2 should refrain from configuring the UE 3 for measurements associated to the selection of frequencies, and wherein the network device 200 is configured to determine whether to at least partially grant the request by being configured to decide to refrain from configuring the UE 3 for measurements associated to the selection of frequencies, and wherein the network device 200 is configured to send a response that provides an indication that the MN 2 will refrain from configuring the UE 3 for measurements associated to the selection of frequencies.

According to a particular embodiment of the proposed technology there is provided a network device 200 wherein the network device 200 is configured to reconfigure the UE 3 to decrease the number of ongoing measurements if the request has been at least partially granted.

According to a particular embodiment of the proposed technology there is provided a network device 200 wherein the SN 1 is an gNodeB and the MN 2 is an eNodeB and wherein the dual connectivity connection is an EN-DC or a NGEN-DC configuration. According to a particular embodiment of the proposed technology there is provided a network device 200 wherein the SN 1 is an eNodeB and the MN 2 is an gNodeB and wherein the dual connectivity connection is an NE-DC configuration.

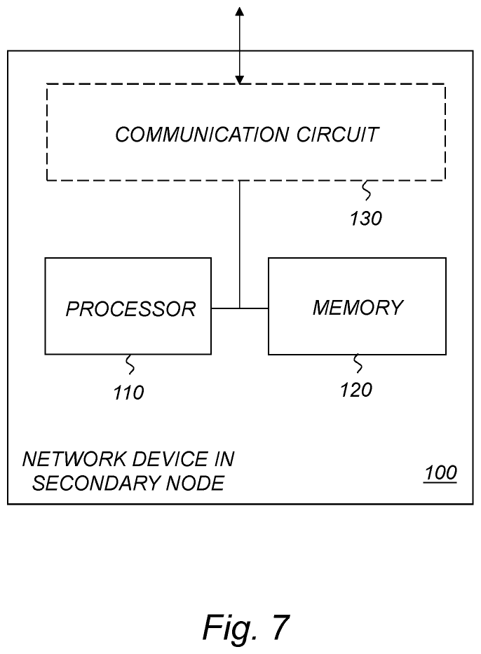

Having provided a general description of network devices 100; 200 in an SN and an MN, respectively, we will now proceed and describe various alternative structures of the network devices with reference to FIGS. 7-10. It should be noted that a general network node typically acts as a Master Node in relation to some UEs served, while it acts as a Secondary Node in relation to other UEs. The two type of acts of the network devices will be described separately, while the physical structures of a network device may support the acts of a Master Node as well as Acts of a Secondary Node.

FIG. 7 is a schematic block diagram illustrating an example of a network device 100 in a SN. The example is based on a processor-memory implementation. In this particular example the network device comprises a communication circuitry 130, at least one processor 110 and memory 120, the memory comprising instructions, which when executed by the at least one processor, cause the at least one processor to configure, based on the response to the request, the UE 3 to perform measurements on at least part of the frequencies in the selection of frequencies. The communication circuitry 130 be connected to the memory 130 and the processor 110. The processor 110 may generate a selection of frequencies the SN 1 wants a UE 3 to perform measurements on and communicate the output to the communication circuitry 130. The communication circuitry 130 will than send a request that comprises the generated frequencies to the Master Node. Based on the response to the request, which may be processed by the processor 110, the communication circuitry 130 sends configuration information to the UE 3 in order for the UE 3 to prepare measurements on at least part of the frequencies in the selection of frequencies.

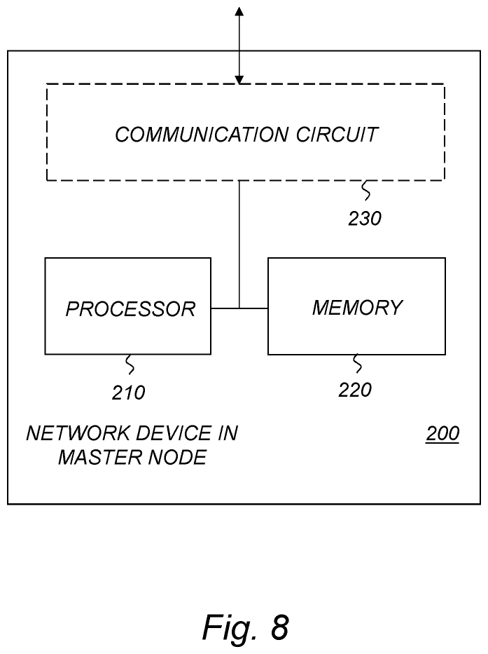

FIG. 8 is a schematic block diagram illustrating instead an example of a network device 200 in a Master Node. This example is based on a processor-memory implementation. In this particular example, the network device 200 comprises a communication circuitry 230, at least one processor 210 and memory 220, the memory comprising instructions, which when executed by the at least one processor, cause the at least one processor to:
read a request comprising a selection of frequencies that the SN 1 wants a UE 3 to perform measurements on; and
determine whether to at least partially grant the request whereby at least a subset of the frequencies comprised in the selection of frequencies are subject to the grant; and
initiate a response to the SN 2, subject to the grant. The communication circuitry 230 is connected to the processor 210 and the memory and receives the request and communicates the request to the processor/memory. The request is read by the processor 210 which also determines whether to grant or partially grant the request. The output is communicated to the communication circuitry that sends a response containing information about the grant to the SN 2.

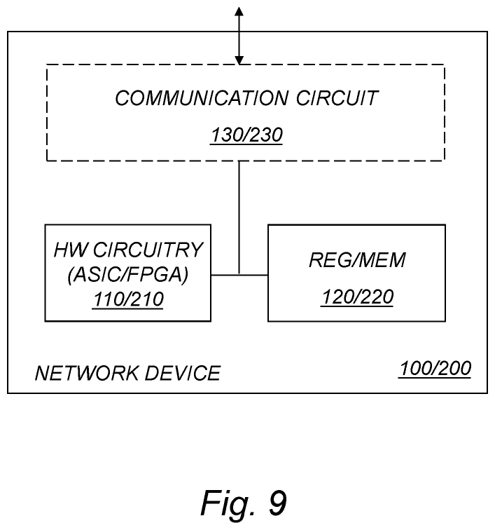

FIG. 9 is a schematic block diagram illustrating another alternative structure of a network device 100/200. This example is based on a hardware circuitry implementation. Particular examples of suitable hardware circuitry 110/210 include one or more suitably configured or possibly reconfigurable electronic circuitry, e.g. Application Specific Integrated Circuits ASICs, Field Programmable Gate Arrays FPGAs, or any other hardware logic such as circuits based on discrete logic gates and/or flip-flops interconnected to perform specialized functions in connection with suitable registers REG and/or memory units MEM 120/220. The network device 100; 200 also include a communication circuit 130; 230. The communication circuit 130; 230 may include functions for wired and/or wireless communication with other devices and/or network nodes in the network. In a particular example, the communication circuit 130; 230 may be based on radio circuitry for communication with one or more other nodes, including transmitting and/or receiving information. The communication circuit 230 may be interconnected to the hardware circuitry 210 and/or REG/MEM 220. By way of example, the communication circuit 130; 230 may include any of the following: a receiver, a transmitter, a transceiver, input/output I/O circuitry, input ports and/or output ports. According to this alternative structure the proposed technology provides a network device 100 in a Secondary Node, SN, 1 in a wireless communication network having a dual connectivity connection where the SN 1 and a Master Node, MN, 2 provides services to at least one User Equipment. The network device 100 generates, in the HW circuitry 110, a request that comprises a selection of frequencies that the SN 1 wants a UE 3 to perform measurements on. The information in the request can be communicated to the communication circuitry 130, either directly or via the passive REG/MEM 120, to enable the communication circuitry to send the request to the MN 2. The communication circuitry 130 also receives a response to the request and may communicate the response to the HW circuitry to enable the latter to determine whether to initiate the sending of configuration information to the UE 3. So based on the response the HW circuitry can output instructions to the communication circuitry 130 that enables the communication circuitry to send configuration information to the UE 3 that enables the UE 3 to perform measurements on at least part of the frequencies in said selection of frequencies.

The alternative structure in FIG. 9 also provides an embodiment for a network device 200 in a Master Node, MN, 2 in a wireless communication network having a dual connectivity connection where the MN 2 and a Secondary Node, SN, 1 provides services to at least one User Equipment, UE 3. The communication circuitry 230 in the network device 200 receive a request comprising a selection of frequencies that the SN 1 wants a UE 3 to perform measurements on. The communication circuitry 230 is connected to the HW circuitry 210 and the REG/MEM 220. The communication circuitry communicates the received request to the HW circuitry 210 to enable the latter to determine, based on, e.g., discrete logic gates and/or flip-flops interconnected to perform the functions, whether to at least partially grant the request whereby at least a subset of the frequencies comprised in said selection of frequencies are subject to the grant. The output from the HW circuitry 210, i.e., a grant, a partial grant with corresponding information or a refusal of the grant can be communicated to the circuitry, either directly or via the REG/MEM circuitry to enable the communication circuitry 230 to communicate a response to request to the SN 2.

The above described embodiments related to the physical structures disclosed in FIGS. 7-8 enables an embodiment where the network devices can be controlled by means of a computer program. To this end the proposed technology provides a computer program 125; 435 for operating, when executed by a processor 110, a network device 100 in a Secondary Node, SN, 1 in a wireless communication network having a dual connectivity connection where the SN 1 and a Master Node, MN, 2 provides services to at least one User Equipment, wherein the computer program comprises instructions, which when executed by the processor 110, cause the processor to:
initiate a sending of a request to the MN 2, the request comprising a selection of frequencies the SN 1 wants a UE 3 to perform measurements on; and
initiate, based on the response to the request, a configuration of the UE 3 to perform measurements on at least part of the frequencies in the selection of frequencies.

The proposed technology provides in addition a computer program 225; 435 for operating, when executed by a processor, a network device 200 in Master Node, MN, 2 in a wireless communication network having a dual connectivity connection where the MN 2 and a Secondary Node, SN, 1 provides services to at least one User Equipment, UE, 3, wherein the computer program comprises instructions, which when executed by the processor 210, cause the processor 210 to:
read a request comprising a selection of frequencies that the SN 1 wants a UE 3 to perform measurements on; and
determine whether to at least partially grant the request whereby at least a subset of the frequencies comprised in the selection of frequencies are subject to the grant; and
initiate, subject to the grant, a sending of a response to the SN 2.

Also provided is a computer program product comprising a computer-readable medium 120;220; carrying a computer program 125; 225; 435 according to the above. By way of example, the software or computer program 125; 225; 435 may be realized as a computer program product, which is normally carried or stored on a computer-readable medium 420; 430, in particular a non-volatile medium. The computer-readable medium may include one or more removable or non-removable memory devices including, but not limited to a Read-Only Memory ROM, a Random Access Memory RAM, a Compact Disc CD, a Digital Versatile Disc DVD, a Blu-ray disc, a Universal Serial Bus USB memory, a Hard Disk Drive HDD storage device, a flash memory, a magnetic tape, or any other conventional memory device. The computer program may thus be loaded into the operating memory of a computer or equivalent processing device for execution by the processing circuitry thereof.

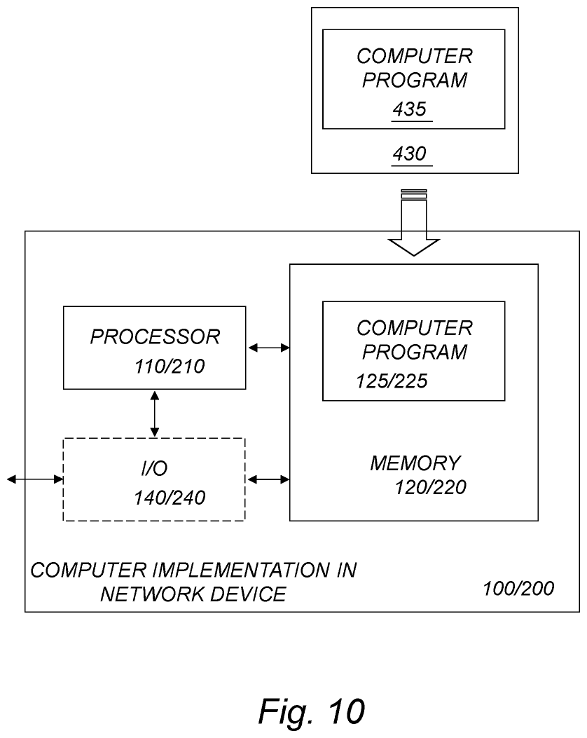

FIG. 10 is a schematic diagram illustrating an example of a computer-implementation of a network device 100/200. In this particular example, at least some of the steps, functions, procedures, modules and/or blocks described herein are implemented in a computer program 125; 225; 435, which is loaded into the memory 120; 220 for execution by processing circuitry including one or more processors 110; 210. The processors 110; 210 and memory 120; 200 are interconnected to each other to enable normal software execution. An optional input/output device 140 may also be interconnected to the processors 110; 210 and/or the memory 120; 200 to enable input and/or output of relevant data such as input parameters and/or resulting output parameters.

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

It is also possible to provide a solution based on a combination of hardware and software. The actual hardware-software partitioning can be decided by a system designer based on a number of factors including processing speed, cost of implementation and other requirements.

The term ‘processor’ should be interpreted in a general sense as any system or device capable of executing program code or computer program instructions to perform a particular processing, determining or computing task.

The processing circuitry including one or more processors 110; 210 is thus configured to perform, when executing the computer program 125; 225, well-defined processing tasks such as those described herein.

The processing circuitry does not have to be dedicated to only execute the above-described steps, functions, procedure and/or blocks, but may also execute other tasks.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

The network device 100; 200 described above may be any suitable network device in the wireless communication system. It may also be a network device in connection with the wireless communication system. By way of example, the network device may be a suitable network node such a base station or an access point. However, the network device may alternatively be a cloud-implemented network device. In what follows we will describe cloud-implemented network devices 100; 200.

It is becoming increasingly popular to provide computing services hardware and/or software in network devices such as network nodes and/or servers where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical nodes, i.e. in the so-called cloud. This is sometimes also referred to as cloud computing, which is a model for enabling ubiquitous on-demand network access to a pool of configurable computing resources such as networks, servers, storage, applications and general or customized services.

There are different forms of virtualization that can be useful in this context, including one or more of:
Consolidation of network functionality into virtualized software running on customized or generic hardware. This is sometimes referred to as network function virtualization.
Co-location of one or more application stacks, including operating system, running on separate hardware onto a single hardware platform. This is sometimes referred to as system virtualization, or platform virtualization.
Co-location of hardware and/or software resources with the objective of using some advanced domain level scheduling and coordination technique to gain increased system resource utilization. This is sometimes referred to as resource virtualization, or centralized and coordinated resource pooling.

By way of example, Software Defined Networking SDN concerns the separation of the control and user plane of today's routers and switches. The user plane processing e.g. filtering and packet forwarding is in most cases performed in hardware by a switch which is controlled by a centralized SDN controller implemented in software. The SDN controller can update rules for packet processing and forwarding in the controlled switches e.g. using protocols such as OpenFlow. This makes it possible to gradually add more advanced functions to the network by updating the SDN controller. SDN can be seen as a lower level of separation of control and user plane compared to the separation of control and user plane nodes between Mobility Management Entities MME and Serving Gateway S-GW in System Architecture Evolution SAE and/or Long Term Evolution LTE.

There is simultaneously a trend leading to consolidation of network functionality into virtualized software running on generic hardware in data centers. This trend is an operator driven forum known as Network Functions Virtualization NFV and aims to take specialized functionality like the functions performed by the mobile packet core such as packet inspection, firewall services, and specialized packet filtering Quality-of-Service differentiation and implement them in software running on generic hardware that is configured to orchestrate the required network functionality.

Storage and processing of large amount of data a.k.a. Big Data is becoming more and more important, even in real-time applications. Storing and processing of large and complex data from e.g. sensors and devices in the networked society often require distributed systems for analytics, collection, search, sharing, storage, transfer, anonymization and virtualization. While, for instance, data analytics as such is not a cloud technology, its implementation often is, especially if the data handled is large.

Distributed, large scale processing on commodity hardware often involves technologies for storage and processing on clusters of commodity hardware.

Although it may often desirable to centralize functionality in so-called generic data centers, in other scenarios it may in fact be beneficial to distribute functionality over different parts of the network.

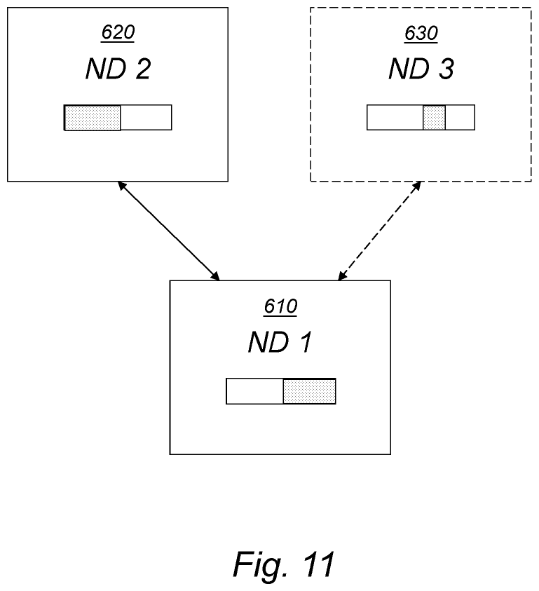

FIG. 11 is a schematic diagram illustrating an example of how functionality can be distributed or partitioned between different network devices in a general case. In this example, there are at least two individual, but interconnected network devices, ND1 and ND2, with reference numerals 610 and 620, respectively, which may have different functionalities, or parts of the same functionality, partitioned between the network devices 610 and 620. There may be additional network devices, such as ND3, with reference numeral 630, being part of such a distributed implementation. The network devices 610-630 may be part of the same wireless communication system, or one or more of the network devices may be so-called cloud-based network devices located outside of the wireless communication system. The functionalities of the proposed technology may be performed by such network devices. It is for example possible to let cloud based network devices to perform a least part of the steps in the proposed method for operating a Secondary Node, SN, 1 in a wireless communication network during a dual connectivity connection where the SN 1 and a Master Node, MN, 2 provides services to at least one User Equipment and where the method comprises sending S1 a request to said MN 2, said request comprising a selection of frequencies the SN 1 wants a UE 3 to perform measurements on, and configuring S2, based on the response to the request, the UE 3 to perform measurements on at least part of the frequencies in the selection of frequencies. The cloud-based network device could to this end generate a set of frequencies that is relevant for the SN to perform measurements on. The cloud-based network device could, based on the set of frequencies initiate a sending of a request to the MN 2, where the request comprises a selection of frequencies the SN 1 wants a UE 3 to perform measurements on. The cloud-based network device could in addition also initiate, based on the response to the request, a configuration of the UE 3 to perform measurements on at least part of the frequencies in the selection of frequencies. That is, the cloud-based network device may perform various decision steps in the method and communicate decision-based actions to the SN in order for the latter to communicate the actions to the UE using the radio interface.

It is in addition to the above possible that a cloud based network device could perform at least some of the steps in a method for operating a Master Node, MN, 2 in a wireless communication network during a dual connectivity connection where the MN 2 and a Secondary Node, SN, 1 provides services to at least one User Equipment, UE, 3, and where the method comprises receiving S10 a request comprising a selection of frequencies that said SN 1 wants a UE 3 to perform measurements on; and the step of determining S20 whether to at least partially grant the request whereby at least a subset of the frequencies comprised in the selection of frequencies are subject to the grant, and finally the step of sending S30, subject to the grant, a response to the SN 2. The cloud-based network device could to this end perform the functions of reading a request comprising a selection of frequencies that the SN 1 wants a UE 3 to perform measurements on and determining whether to at least partially grant the request whereby at least a subset of the frequencies comprised in the selection of frequencies are subject to the grant, and then initiate, subject to the grant, a sending of a response to the SN 2. It is thus possible to distribute the functionalities between a cloud-based node and the base station. The base station, i.e., the MN, will receive a request from the SN. This request can be communicated to a cloud-based network device that is configured to perform at least the step of determining whether to grant the request. The outcome of this determining step may then be communicated back to the base station, optionally together with instructions of actions for the base station to perform, e.g., sending a response to the SN over the radio interface or over some other interface connecting the SN and the MN.

A Network Device ND as described above may generally be seen as an electronic device being communicatively connected to other electronic devices in the network.

By way of example, the network device described above may be implemented in hardware, software or a combination thereof. For example, the network device may be a special-purpose network device or a general purpose network device, or a hybrid thereof.

A special-purpose network device as described above may use custom processing circuits and a proprietary operating system OS, for execution of software to provide one or more of the features or functions disclosed herein.

A general purpose network device as described above may use common off-the-shelf COTS processors and a standard OS, for execution of software configured to provide one or more of the features or functions disclosed herein.

By way of example, a special-purpose network device may include hardware comprising processing or computing resources, which typically include a set of one or more processors, and physical network interfaces Nis, which sometimes are called physical ports, as well as non-transitory machine readable storage media having stored thereon software. A physical NI may be seen as hardware in a network device through which a network connection is made, e.g. wirelessly through a wireless network interface controller WNIC or through plugging in a cable to a physical port connected to a network interface controller NIC. During operation, the software may be executed by the hardware to instantiate a set of one or more software instances. Each of the software instances, and that part of the hardware that executes that software instance, may form a separate virtual network element.

By way of another example, a general purpose network device may for example include hardware comprising a set of one or more processors, often COTS processors, and network interface controllers NICs, as well as non-transitory machine readable storage media having stored thereon software. During operation, the processors executes the software to instantiate one or more sets of one or more applications. While one embodiment does not implement virtualization, alternative embodiments may use different forms of virtualization—for example represented by a virtualization layer and software containers. For example, one such alternative embodiment implements operating system-level virtualization, in which case the virtualization layer represents the kernel of an operating system or a shim executing on a base operating system that allows for the creation of multiple software containers that may each be used to execute one of a sets of applications. In an example embodiment, each of the software containers also called virtualization engines, virtual private servers, or jails is a user space instance typically a virtual memory space. These user space instances may be separate from each other and separate from the kernel space in which the operating system is executed; the set of applications running in a given user space, unless explicitly allowed, cannot access the memory of the other processes. Another such alternative embodiment implements full virtualization, in which case: 1 the virtualization layer represents a hypervisor sometimes referred to as a Virtual Machine Monitor VMM or the hypervisor is executed on top of a host operating system; and 2 the software containers each represent a tightly isolated form of software container called a virtual machine that is executed by the hypervisor and may include a guest operating system.

A hypervisor is the software/hardware that is responsible for creating and managing the various virtualized instances and in some cases the actual physical hardware. The hypervisor manages the underlying resources and presents them as virtualized instances. What the hypervisor virtualizes to appear as a single processor may actually comprise multiple separate processors. From the perspective of the operating system, the virtualized instances appear to be actual hardware components.

A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications as well as the virtualization layer and software containers if implemented, are collectively referred to as software instances. Each set of applications, corresponding software container if implemented, and that part of the hardware that executes them be it hardware dedicated to that execution and/or time slices of hardware temporally shared by software containers, forms a separate virtual network elements.

The virtual network elements may perform similar functionality compared to Virtual Network Elements VNEs. This virtualization of the hardware is sometimes referred to as Network Function Virtualization NFV. Thus, NFV may be used to consolidate many network equipment types onto industry standard high volume server hardware, physical switches, and physical storage, which could be located in data centers, NDs, and Customer Premise Equipment CPE. However, different embodiments may implement one or more of the software containers differently. For example, while embodiments are illustrated with each software container corresponding to a VNE, alternative embodiments may implement this correspondence or mapping between software container-VNE at a finer granularity level; it should be understood that the techniques described herein with reference to a correspondence of software containers to VNEs also apply to embodiments where such a finer level of granularity is used.

According to yet another embodiment, there is provided a hybrid network device, which includes both custom processing circuitry/proprietary OS and COTS processors/standard OS in a network device, e.g. in a card or circuit board within a network device ND. In certain embodiments of such a hybrid network device, a platform Virtual Machine VM, such as a VM that implements functionality of a special-purpose network device, could provide for para-virtualization to the hardware present in the hybrid network device.

### APPENDIX

The Secondary Node Addition procedure is used to add a Secondary Cell Group, SCG, for a UE. This procedure is specified in 3GPP TS 37.340 for EN-DC and MR-DC with 5GC as follows:

The Secondary Node Addition procedure is initiated by the MN and is used to establish a UE context at the SN to provide resources from the SN to the UE. For bearers requiring SCG radio resources, this procedure is used to add at least the first cell of the SCG. This procedure can also be used to configure an SN terminated MCG bearer where no SCG configuration is needed.

In step 1 the MN decides to request the SN to allocate resources for a specific E-RAB, indicating E-RAB characteristics, e.g., E-RAB parameters and TNL address information corresponding to bearer typ. In addition, for bearers requiring SCG radio resources, MN indicates the requested SCG configuration information, including the entire UE capabilities and the UE capability coordination result. In this case, the MN also provides the latest measurement results for SN to choose and configure the SCG cells. The MN may request the SN to allocate radio resources for split SRB operation. The MN always provides all the needed security information to the SN, even if no SN terminated bearers are setup, to enable SRB3 to be setup based on SN decision. In case of bearer options that require X2-U resources between the MN and the SN, the MN provides X2-U TNL address information for the respective E-RAB, X2-U DL TNL address information for SN terminated bearers, X2-U UL TNL address information for MN terminated bearers. In case of SN terminated split bearers the MN provides the maximum QoS level that it can support. The SN may reject the request. Note that for split bearers, MCG and SCG resources may be requested of such an amount, that the QoS for the respective E-RAB is guaranteed by the exact sum of resources provided by the MCG and the SCG together, or even more. For MN terminated split bearers, the MNs decision is reflected in step 1 by the E-RAB parameters signaled to the SN, which may differ from E-RAB parameters received over 51. Note also that for a specific E-RAB, the MN may request the direct establishment of an SCG or a split bearer, i.e., without first having to establish an MCG bearer. It is also allowed that all E-RABs can be configured as SN terminated bearers, i.e. there is no E-RAB established as an MN terminated bearer.

In step 2, if the RRM entity in the SN is able to admit the resource request, it allocates respective radio resources and, dependent on the bearer option, respective transport network resources. For bearers requiring SCG radio resources, the SN triggers Random Access so that synchronization of the SN radio resource configuration can be performed. The SN decides the Pscell and other SCG Scells and provides the new SCG radio resource configuration to the MN in a NR RRC configuration message contained in the SgNodeB Addition Request Acknowledge message. In case of bearer options that require X2-U resources between the MN and the SN, the SN provides X2-U TNL address information for the respective E-RAB, X2-U UL TNL address information for SN terminated bearers, X2-U DL TNL address information for MN terminated bearers. For SN terminated bearers, the SN provides the S1-U DL TNL address information for the respective E-RAB and security algorithm. If SCG radio resources have been requested, the SCG radio resource configuration is provided. Note that for the SN terminated split bearer option, the SN may either decide to request resources from the MN of such an amount, that the QoS for the respective E-RAB is guaranteed by the exact sum of resources provided by the MN and the SN together, or even more. The SNs decision is reflected in step 2 by the E-RAB parameters signaled to the MN, which may differ from E-RAB parameters received in step 1. The QoS level requested from the MN shall not exceed the level that the MN offered when setting up the split bearer in step 1. It should be noted that in the case of MN terminated bearers, transmission of user plane data may take place after step 2. Note also that in case of SN terminated bearers, data forwarding and the SN Status Transfer may take place after step 2.

In step 3 the MN sends to the UE the RRC-Connection-Reconfiguration message including the NR RRC configuration message, without modifying it.

In step 4 the UE applies the new configuration and replies to MN with RRC-Connection-Reconfiguration-Complete message, including a NR RRC response message, if needed. In case the UE is unable to comply with part of the configuration included in the RRC-Connection-Reconfiguration message, it performs the reconfiguration failure procedure.

In step 5 the MN informs the SN that the UE has completed the reconfiguration procedure successfully via SgNodeB Reconfiguration-Complete message, including the encoded NR RRC response message, if received from the UE.

In step 6, if configured with bearers requiring SCG radio resources, the UE performs synchronization towards the PSCell of the SN. The order the UE sends the RRC-Connection-Reconfiguration-Complete message and performs the Random-Access procedure towards the SCG is not defined. The successful RA procedure towards the SCG is not required for a successful completion of the RRC Connection Reconfiguration procedure.

In step 7, and in case of SN terminated bearers using RLC AM, the MN sends SN Status Transfer.

In step 8, in case of SN terminated bearers using RLC AM, and dependent on the bearer characteristics of the respective E-RAB, the MN may take actions to minimize service interruption due to activation of EN-DC, i.e., Data forwarding.

In steps 9-12, and for SN terminated bearers, the update of the UP path towards the EPC is performed.

Another possibility relates to a SN Modification procedure with SN initiated with MN involvement. The SN uses this procedure to perform configuration changes of the SCG within the same SN, e.g., in order to trigger the release of SCG bearers and the SCG RLC bearer of split bearers, upon which the MN may release the bearer or maintain current bearer type or reconfigure it to an MCG bearer, either MN terminated or SN terminated, and to trigger PSCell change, e.g., when a new security key is required or when the MN needs to perform PDCP data recovery. The MN cannot reject the release request of SCG bearer and the SCG RLC bearer of a split bearer.

In step 1 the SN sends the SgNodeB Modification Required message including a NR RRC configuration message, which may contain bearer context related, other UE context related information and the new SCG radio resource configuration. For bearer release or modification, a corresponding E-RAB list is included in the SgNodeB Modification Required message. In case of change of security key, the PDCP Change Indication indicates that a S-KgNodeB update is required. In case the MN needs to perform PDCP data recovery, the PDCP Change Indication indicates that PDCP data recovery is required. The SN can decide whether the change of security key is required.

In steps 2/3 the MN initiated SN Modification procedure may be triggered by the SN Modification Required message, e.g., to provide information such as data forwarding addresses, new SN security key, measurement gap, etc. Note that if only SN security key is provided in step 2, the MN does not need to wait for the reception of step 3 to initiate the RRC connection reconfiguration procedure.

In step 4 the MN sends the RRC-Connection-Reconfiguration message including a NR RRC configuration message to the UE including the new SCG radio resource configuration.

In step 5 the UE applies the new configuration and sends the RRC-Connection-Reconfiguration-Complete message, including an encoded NR RRC response message, if needed. In case the UE is unable to comply with part of the configuration included in the RRC-Connection-Reconfiguration message, it performs the reconfiguration failure procedure.

In step 6, upon successful completion of the reconfiguration, the success of the procedure is indicated in the SgNodeB Modification Confirm message containing the encoded NR RRC response message, if received from the UE.

In step 7, if instructed, the UE performs synchronization towards the PSCell of the SN as described in SN addition procedure. Otherwise, the UE may perform UL transmission after having applied the new configuration.

In step 8, if PDCP termination point is changed for bearers using RLC AM, and when RRC full configuration is not used, the SN sends the MN Status transfer.

In step 9, if applicable, data forwarding between MN and the SN takes place. FIG. 3 depicts the case where a bearer context is transferred from the SN to the MN.

In step 10 The SN sends the Secondary RAT Data Volume Report message to the MN and includes the data volumes delivered to the UE over the NR radio for the E-RABs to be released.

Note that the order the SN sends the Secondary RAT Data Volume Report message and performs data forwarding with MN is not defined. The SN may send the report when the transmission of the related bearer is stopped.

In step 11, if applicable, a path update is performed.

Yet another possibility relates to a SN modification where the SN is initiated without MN involvement. The SN initiated modification without MN involved procedure is used to modify the configuration within SN in case no coordination with MN is required, including the addition/modification/release of SCG Scell and PSCell change, e.g., when the security key does not need to be changed and the MN does not need to be involved in PDCP recovery.

In step 1 the SN sends the RRC-Connection-Reconfiguration message to the UE through SRB3. The UE applies the new configuration. In case the UE is unable to comply with part of the configuration included in the RRC-Connection-Reconfiguration message, it performs the reconfiguration failure procedure.

In step 2, if instructed, the UE performs synchronization towards the PsCell of the SN.

In step 3 the UE replies with an RRC-Connection-Reconfiguration-Complete message.

### ABBREVIATIONS

At least some of the following abbreviations may be used in this disclosure. If there is an inconsistency between abbreviations, preference should be given to how it is used above. If listed multiple times below, the first listing should be preferred over any subsequent listings.
DC Intra-E-UTRA Dual Connectivity
EN-DC E-UTRA-NR Dual Connectivity
MCG Master Cell Group
MN Master Node
MR-DC Multi-Radio Dual Connectivity
NE-DC NR-E-UTRA Dual Connectivity
NGEN-DC NG-RAN E-UTRA-NR Dual Connectivity
NR-DC NR-NR Dual Connectivity
SCG Secondary Cell Group
SN Secondary Node
SRB Signal Radio Bearer

1. A method for operating a Secondary Node, SN, in a wireless communication network during a dual connectivity connection where said SN and a Master Node, MN, provides services to at least one User Equipment, the method comprises:
sending a request to said MN, said request comprising a selection of frequencies the SN wants a UE to perform measurements on; and
configuring, based on the response to said request, said UE to perform measurements on at least part of the frequencies in said selection of frequencies.

2. The method according to claim 1, wherein said request further comprises instructions that the MN should refrain from configuring said UE for measurements connected to said selection of frequencies comprised in said request.

3. The method according to claim 1, wherein the request is sent to the MN in a new information element provided in an existing message type.

4. The method according to claim 1, wherein said SN is an gNodeB and said MN is an eNodeB and wherein said dual connectivity connection is an EN-DC or a NGEN-DC configuration.

5. The method according to claim 1, wherein said SN is an eNodeB and said MN is an gNodeB and wherein said dual connectivity connection is a NE-DC configuration.

6. A method for operating a Master Node, MN, in a wireless communication network during a dual connectivity connection where said MN and a Secondary Node, SN, provides services to at least one User Equipment, UE, the method comprises:
receiving a request comprising a selection of frequencies that said SN wants a UE to perform measurements on;
determining whether to at least partially grant said request whereby at least a subset of the frequencies comprised in said selection of frequencies are subject to the grant; and
sending, subject to said grant, a response to said SN.

7. The method according to claim 6, wherein the step of determining whether to at least partially grant said request comprises to grant said request in whole if the number of frequencies in said selection of frequencies is lower or equal to the number of frequencies that the UE can perform measurements on.

8. The method according to claim 6, wherein the step of determining whether to at least partially grant said request comprises to grant said request for a fraction of the frequencies comprised in said selection of frequencies, said fraction being determined by the number of frequencies that the UE can perform measurements on.

9. The method according to claim 7, wherein the step of determining whether to at least partially grant said request comprises to grant said request if the selection of frequencies the SN wants a UE to perform measurements on does not increase the number of frequencies that said UE is able to perform measurements on.

10. The method according to claim 6, wherein the step of sending a response comprises to send a response that instructs said SN to configure said UE to perform measurement on at least the subset of frequencies subjected to said grant.

11. The method according to claim 6, wherein the step of sending a response comprises to send a response indicating the maximum number of frequencies that the SN is allowed to configure said UE for measurements on.

12. The method according to claim 6, wherein said received request further comprises a request that said MN should refrain from configuring said UE for measurements associated to said selection of frequencies, and wherein the step of determining whether to at least partially grant said request comprises deciding to refrain from configuring said UE for measurements associated to said selection of frequencies, and wherein the step of sending a response comprises to send a response that indicates that said MN will refrain from configuring said UE for measurements associated to said selection of frequencies.

13. The method according to claim 6, wherein the method further comprises to reconfigure said UE to decrease the number of ongoing measurements if said request has been at least partially granted.

14. The method according to claim 6, wherein said SN is an gNodeB and said MN is an eNodeB and wherein said dual connectivity connection is an EN-DC or a NGEN-DC configuration.

15. The method according to claim 6, wherein said SN is an eNodeB and said MN is an gNodeB and wherein said dual connectivity connection is an NE-DC configuration.

16. A network device in a Secondary Node, SN, in a wireless communication network having a dual connectivity connection where said SN and a Master Node, MN, provides services to at least one User Equipment, wherein said network device is configured to:
send a request to said MN, said request comprising a selection of frequencies the SN wants a UE to perform measurements on; and
configure, based on the response to said request, said UE to perform measurements on at least part of the frequencies in said selection of frequencies.

17. The network device according to claim 16, wherein said request further comprises instructions that the MN should refrain from configuring said UE for measurements connected to said selection of frequencies comprised in said request.

18. The network device according to claim 16, wherein network device is configured to send the request to the MN in a new information element provided in an existing message type.

19. The network device according to claim 16, wherein said SN is an gNodeB and said MN is an eNodeB and wherein said dual connectivity connection is an EN-DC or a NGEN-DC configuration.

20. (canceled)

21. (canceled)

22. A network device in a Master Node, MN, in a wireless communication network having a dual connectivity connection where said MN and a Secondary Node, SN, provides services to at least one User Equipment, UE, the network device is configured:
receive a request comprising a selection of frequencies that said SN wants a UE to perform measurements on;
determine whether to at least partially grant said request whereby at least a subset of the frequencies comprised in said selection of frequencies are subject to the grant; and
send, subject to said grant, a response to said SN.

23-35. (canceled)
